(19) United States
(12) Patent Application Publication
(10) Pub. No.: US 2014/0156475 A1
(43) Pub. Date: Jun. 5, 2014

(54) MULTI-LEVEL WORK HOUR ROUNDING BASED ON ROUNDING RULES

(71) Applicant: VERIZON PATENT AND LICENSING INC., Basking Ridge, NJ (US)

(72) Inventor: Neelakantan STHANUMOORTHY, Irving, TX (US)

(73) Assignee: Verizon Patent and Licensing Inc., Basking Ridge, NJ (US)

(21) Appl. No.: 13/705,630

(22) Filed: Dec. 5, 2012

(51) Int. Cl. G06Q 10/10

(52) U.S. Cl. CPC G06Q 10/1091
USPC 705/32

(57) ABSTRACT

A first server may: store a first start time and a first end time; receive a data record having a second start time and a second end time; determine a first number of time units corresponding to a total number of time units between the first start time and the first end time; determine a second number of time units corresponding to a difference between the first start time and the second start time; apply a first rounding rule to the second number of time units to form a first rounded number; determine a second rounded number by subtracting the first rounded number from the first number of time units; apply a second rounding rule to the second rounded number to form a third rounded number; and provide the third rounded number to a second server to determine a payment based on a rate and the third rounded number.

### BACKGROUND

Calculating work hours for an employee is sometimes based on work hour rounding rules, such as rules associated with collective bargaining agreements (CBAs). Different work hours for different employees may be subject to different CBAs or other rounding rules, thereby making calculation of work hours and calculation of wage payment to workers a cumbersome and sometimes inaccurate process.

### BRIEF DESCRIPTION OF THE DRAWINGS

FIG. 1 illustrates an example overview of an implementation described herein;

FIG. 2 illustrates an example environment in which systems and/or methods, described herein, may be implemented;

FIG. 3 illustrates example components of a device that may be used within the environment of FIG. 2;

FIGS. 4A-4C illustrate an example data structure that may be stored by one or more devices in the environment of FIG. 2;

FIG. 5 illustrates a flowchart of an example process for determining work hours based on multiple rounding rules; and

FIG. 6 illustrates an example use case for calculating payable minutes.

### DETAILED DESCRIPTION OF THE PREFERRED EMBODIMENTS

The following detailed description refers to the accompanying drawings. The same reference numbers in different drawings may identify the same or similar elements.

Systems and/or methods, as described herein, may determine a number of work hours (e.g., as related to wage payment) for an employee based on multiple levels of rounding and based on multiple rounding rules. In some implementations, the rounding rules may be associated with a CBA, an employment contract, or some other type of wage agreement.

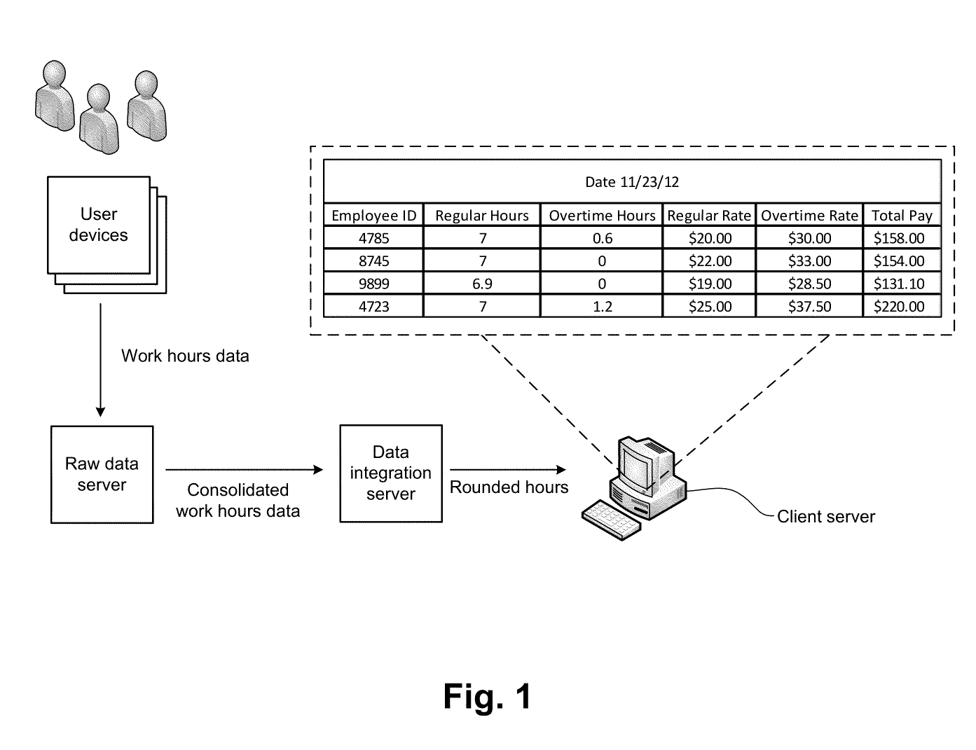

FIG. 1 illustrates an example overview of an implementation described herein. In FIG. 1, assume that multiple employees each use a respective user device to conduct work-related duties, such as duties relating to customer service via telephone, or some other work-related duty. In some implementations, the user device may track work hours of the user based on user interaction between the user and the user device. As an example, assume that an employee having an employee ID of 4785 worked from the time periods of 9:08 AM-12:30 PM and from 1:30 PM to 5:39 PM. Thus, the user device may generate a work hours data record to indicate that the employee, having the employee ID of 4785, worked from the time periods of 9:08 AM-12:30 PM and from 1:30 PM to 5:39 PM.

As shown in FIG. 1, the user device may send work hours data, to a raw data server, in a format that identifies a user (e.g., an employee identifier (ID)), a date in which work was performed, and a time period corresponding to a number of minutes worked. In some implementations, the raw data server may receive work hours data from multiple user devices and generate consolidated work hours data having work hours data from the multiple user devices.

As further shown in FIG. 1, a data integration server may receive the consolidated work hours data and may apply multiple levels of rounding rules to generate rounded hours data. For example, the data integration server may round up or down overtime minutes, round up or down regular work shift minutes, or round up or down tardy minutes based on a CBA associated with a particular employee ID. In some implementations, the data integration server may provide the rounded hours data to a client server (e.g., a wage payment processing server) in a format that identifies wage hours by hours type (e.g., regular hours, overtime hours, etc.). In some implementations, the client server may store information that identifies wage payment rates by hour type and may determine wage payments for individual users (e.g., individual employees). In some implementations, the client server may present wage payment information in a chart format, or in some other format. Thus, the client server may determine wage payments in accordance with a set of rounding rules (e.g., rounding rules corresponding to a CBA), without providing wage rate information to the data integration server.

While a particular example of the systems and/or methods is described with respect to FIG. 1, it will be apparent that the above description is merely an example implementation and in practice, the systems and/or methods may function differently than what is shown in FIG. 1. Also, while the systems and/or methods are described in terms of determining work hours for wage payment purposes, the systems and/or methods are not so limited. For example, the systems and/or methods may be used to determine some other type of data for some other purpose not described. Also, work hours may be expressed in terms of minutes, hours, or some other unit of measure.

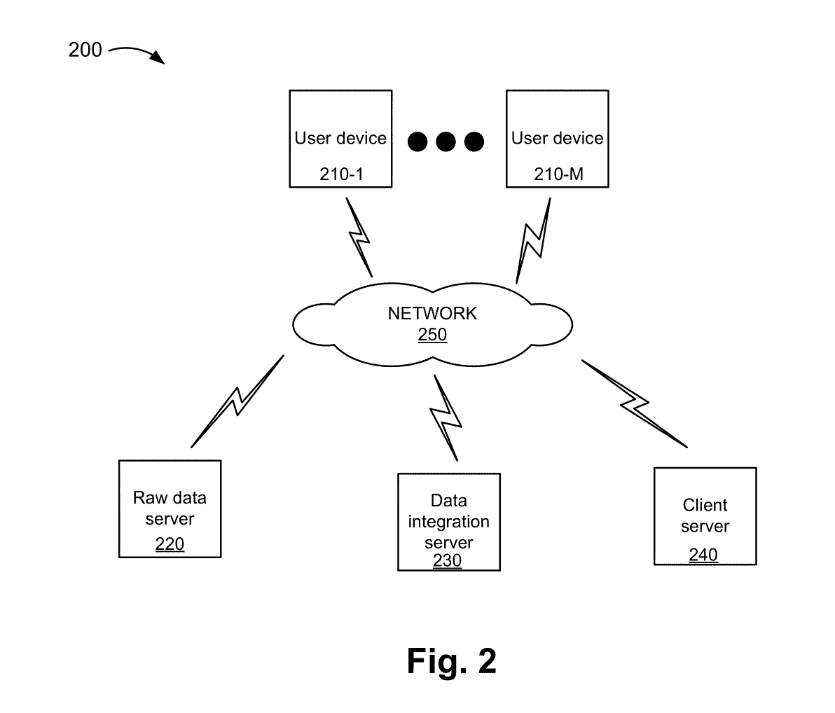

FIG. 2 is a diagram of an example environment 200 in which systems and/or methods described herein may be implemented. As shown in FIG. 2, environment 200 may include user device 210-1, . . . , 210-M (where M≧1), raw data server 220, data integration server 230, client server 240, and network 250.

User device 210 may include a device capable of communicating via a network, such as network 250. For example, user device 210 may correspond to a work activity tracking device, such as a call logging device, a desktop computing device, or some other type of device relating to performing work-related activity. In some implementations, a particular user device 210 may be associated with a particular user (e.g., a particular employee) and may provide information regarding work hours for the particular user to raw data server 220 (e.g., a work hours data record including information regarding an employee ID and a time period corresponding to a number of time units worked). In some implementations, the time units may be expressed in minutes, hours, seconds, or some other unit of time measurement.

Raw data server 220 may include a computing device, such as a server device, or a collection of server devices. In some implementations, raw data server 220 may receive work hours data records for respective users of user device 210 from user device 210. As described above, raw data server 220 may consolidate multiple sets of work hours data records received from multiple user devices 210 and provide the multiple sets of work hours data records to data integration server 230.

Data integration server 230 may include a computing device, such as a server device, or a collection of server devices. In some implementations data integration server 230 may receive a work hours data record for a user of user device 210 when the user of user device 210 uses user device 210 to perform a work-related task. In some implementations, data integration server 230 may store employee information, such as an employee ID and an employee work schedule. Additionally, data integration server 230 may store rounding rules and error codes to identify work hours data records that may have been duplicated or have some other type of defect. Data integration server 230 may determine work hours by work hour type (e.g., regular work hours, tardy hours, overtime hours, etc.), may perform error processing functions, and may perform rounding functions to determine rounded (e.g., payable) work hours for processing by client server 240.

Client server 240 may include a computing device, such as a server device, or a collection of server devices. In some implementations, client server 240 may be associated with a wage payment processor to process and/or issue wage payments for employees of user devices 210. For example, client server 240 may store wage rates per hour by employee and/or by wage rule (e.g., a wage associated with a CBA of a particular employee). As described above, client server 240 may receive payable hours from data integration server 230 and may determine a wage payment for a particular employee based on wage rates and based on the payable hours. In some implementations, client server 240 may present wage payment information in a chart format, or in some other format.

Network 250 may include one or more wired and/or wireless networks. For example, network 250 may include a cellular network, a public land mobile network (PLMN), a second generation (2G) network, a third generation (3G) network, a fourth generation (4G) network, a fifth generation (5G) network, and/or another network. Additionally, or alternatively, network 250 may include a local area network (LAN), a wide area network (WAN), a metropolitan network (MAN), a telephone network (e.g., the Public Switched Telephone Network (PSTN)), an ad hoc network, a managed IP network, a virtual private network (VPN), an intranet, the Internet, a fiber optic-based network, and/or combination of these or other types of networks.

The quantity of devices and/or networks, illustrated in FIG. 2, is not limited to what is shown. In practice, there may be additional devices and/or networks; fewer devices and/or networks; different devices and/or networks; or differently arranged devices and/or networks than illustrated in FIG. 2. Also, in some implementations, one or more of the devices of environment 200 may perform one or more functions described as being performed by another one or more of the devices of environment 200. Devices of environment 200 may interconnect via wired connections, wireless connections, or a combination of wired and wireless connections.

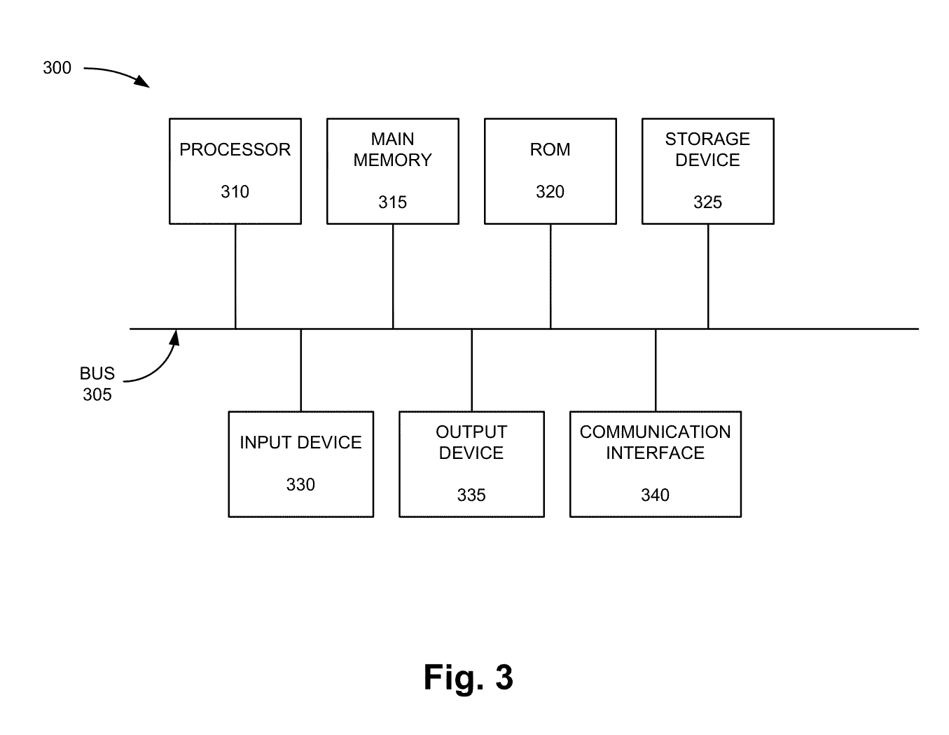

FIG. 3 illustrates example components of a device 300 that may be used within environment 200 of FIG. 2. Device 300 may correspond to user device 210, raw data server 220, data integration server 230, or client server 240. Each of user device 210, raw data server 220, data integration server 230, or client server 240 may include one or more devices 300, and/or one or more components of device 300.

As shown in FIG. 3, device 300 may include a bus 305, a processor 310, a main memory 315, a read only memory (ROM) 320, a storage device 325, an input device 330, an output device 335, and a communication interface 340. In some implementations, device 300 may include additional components, fewer components, different components, or differently arranged components.

Bus 305 may include a path that permits communication among the components of device 300. Processor 310 may include a processor, a microprocessor, an application specific integrated circuit (ASIC), a field programmable gate array (FPGA), or another type of processor that interprets and executes instructions. Main memory 315 may include a random access memory (RAM) or another type of dynamic storage device that stores information or instructions for execution by processor 310. ROM 320 may include a ROM device or another type of static storage device that stores static information or instructions for use by processor 310. Storage device 325 may include a magnetic storage medium, such as a hard disk drive, or a removable memory, such as a flash memory.

Input device 330 may include a component that permits an operator to input information to device 300, such as a control button, a keyboard, a keypad, or another type of input device. Output device 335 may include a component that outputs information to the operator, such as a light emitting diode (LED), a display, or another type of output device. Communication interface 340 may include any transceiver-like mechanism that enables device 300 to communicate with other devices or networks. In one implementation, communication interface 340 may include a wireless interface, a wired interface, or a combination of a wireless interface and a wired interface.

Device 300 may perform certain operations, as described in detail below. Device 300 may perform these operations in response to processor 310 executing software instructions contained in a computer-readable medium, such as main memory 315. A computer-readable medium may be defined as a non-transitory memory device. A memory device may include memory space within a single physical storage device or memory space spread across multiple physical storage devices.

The software instructions may be read into main memory 315 from another computer-readable medium, such as storage device 325, or from another device via communication interface 340. The software instructions contained in main memory 315 may direct processor 310 to perform processes that will be described later. Alternatively, hardwired circuitry may be used in place of or in combination with software instructions to implement processes described herein. Thus, implementations described herein are not limited to any specific combination of hardware circuitry and software.

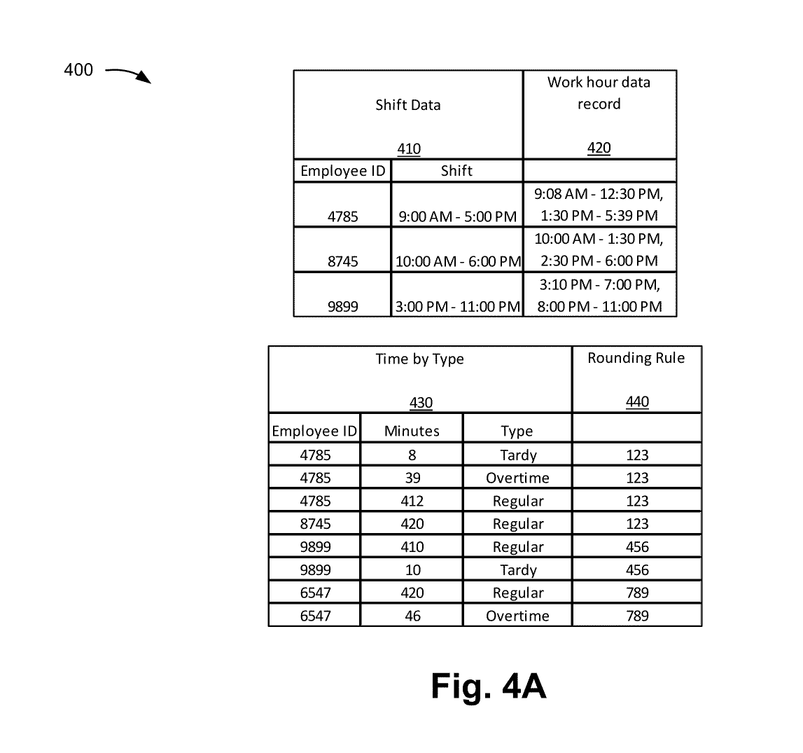

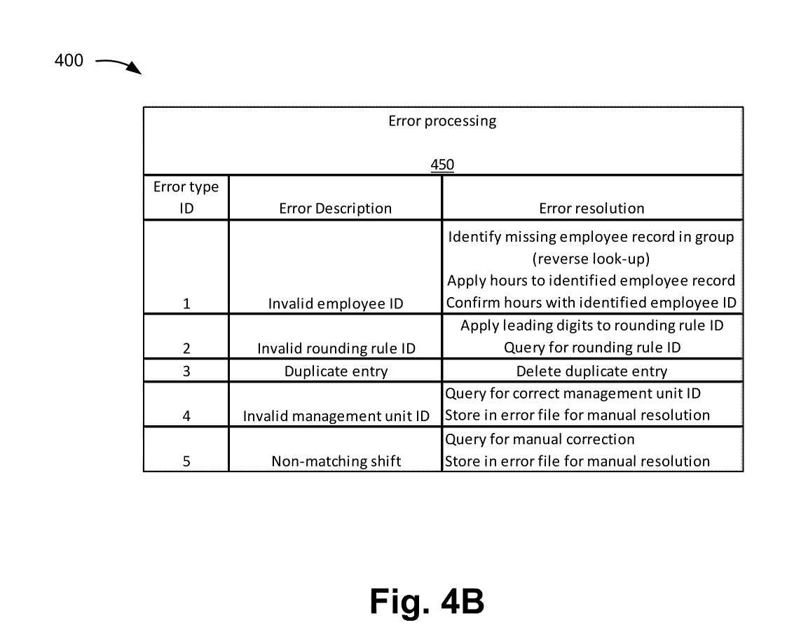

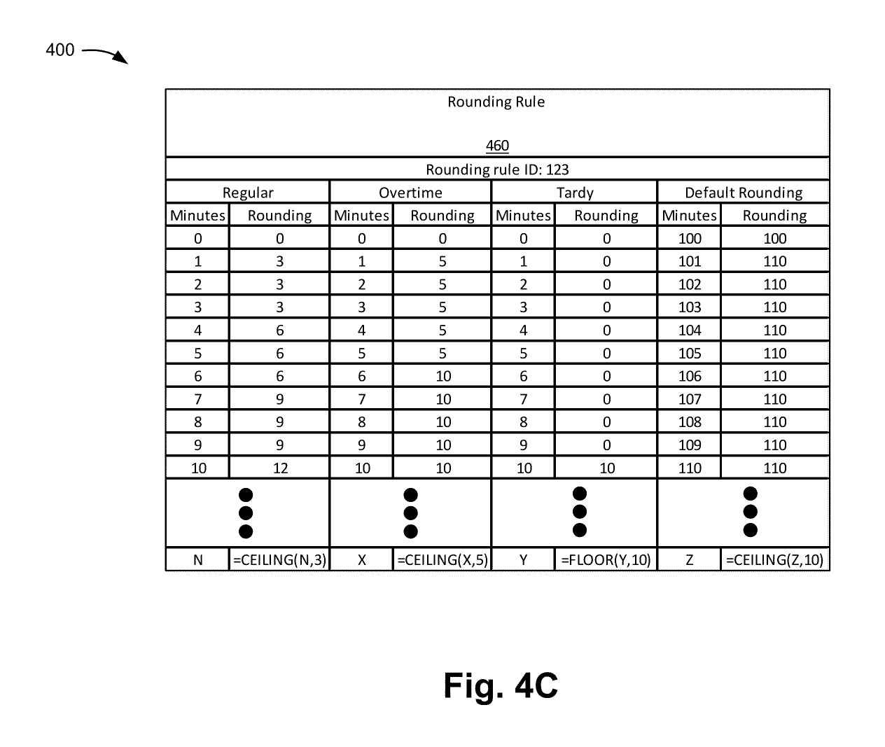

FIGS. 4A-4C illustrate an example data structure 400 that may be stored by one or more devices in environment 200, such as data integration server 230. In one implementation, data structure 400 may be stored in a memory of data integration server 230. In another implementation, data structure 400 may be stored in a memory separate from, but accessible by data integration server 230. In some implementations, data structure 400 may be stored by some other device in environment 200, such as user device 210, raw data server 220, or client server 240.

A particular instance of data structure 400 may contain different information and/or fields than another instance of data structure 400. In some implementations, data structure 400 may store information associated with a work shift for an employee, and information associated with time worked by an employee and type of time. Data structure 400 may also store information for error types for work hours data records received by raw data server 220, and information corresponding to a rounding rule.

As shown in FIGS. 4A-4C, data structure 400 may include shift data field 410, work hours data record field 420, time by type field 430, rounding rule field 440, error processing field 450, and rounding rule field 460.

Shift data field 410 may store information identifying a work shift for an employee. For example, each entry in shift data field 410 may identify a particular employee by employee identifier (ID) and may identify a scheduled work shift start time and a scheduled work shift end time corresponding to the employee ID. As an example shown in FIG. 4A, shift data field 410 may store information to identify a scheduled work shift of 9:00 AM-5:00 PM (e.g., a work shift start time of 9:00 AM and a work shift end time of 5:00 PM) for the employee having the employee ID of 4785. In some implementations, shift data field 410 may store additional information not shown in FIG. 4A, such as a date for the work shift or a scheduled work shift break. In FIG. 4A, assume that data stored by data structure 400 includes data associated with the same date and associated with a one hour work shift break.

Work hours data record field 420 may store information for a work hours data record received by raw data server 220 relating to time worked by a particular employee. For example, as described above, raw data server 220 may receive information from user device 210 indicative of time worked by the particular employee (e.g., based on interaction between user device 210 and the particular employee). As an example, assume that the employee, having the employee ID of 4785, worked the time periods of 9:08 AM to 12:30 PM and 1:30 PM to 5:39 PM. Thus, raw data server 220 and/or user device 210 may generate a work hours data record to indicate that the employee, having the employee ID, of 4785 worked the time periods of 9:08 AM to 12:30 PM and from 1:30 PM to 5:39 PM. In this case, work hours data record field 420 may store the time periods of 9:08 AM to 12:30 PM and 1:30 PM to 5:39 PM for the employee ID of 4785.

Time by type field 430 may store information to identify a type of work hours associated with a particular employee ID. In some implementations, time by type field 430 may store information identifying a number of minutes, corresponding to information in a work hours data record for a particular employee ID, and a type corresponding to the minutes (e.g., “tardy” minutes, “regular” minutes, “overtime” minutes, or some other type of minutes). For example, data integration server 230 may determine a number of minutes and the type of minutes based on information stored by shift data field 410 and work hours data record field 420. Data integration server 230 may determine a number of tardy minutes by determining a number of minutes between a time in which the employee began work (e.g., based on information stored by work hours data record field 420) and a scheduled work shift begin time (e.g., based on information stored by shift data field 410). As an example, data integration server 230 may determine a number of eight tardy minutes for the employee having the employee ID of 4785 since the information stored by work hours data record field 420 indicates that the employee began work at 9:08 AM and the information stored by shift data field 410 indicates a shift start time of 9:00 AM. Thus, time by type field 430 may store a value of eight corresponding to the tardy time type and the employee ID of 4785.

Data integration server 230 may also determine a number of overtime minutes by determining a number of minutes between a time in which an employee ended work and a scheduled work shift end time. As an example, data integration server 230 may determine a number of 39 overtime minutes for the employee ID of 4785 since the information stored by work hours data record field 420 indicates that the employee ended work at 5:39 PM and the information stored by shift data field 410 indicated a shift end time of 5:00 PM. Thus, time by type field 430 may store a value of 39 corresponding to the overtime time type and the employee ID of 4785.

Data integration server 230 may also determine a number of regular minutes by determining a number of minutes worked by the employee within a timeframe corresponding to a work shift. As an example, data integration server 230 may determine a number of 412 regular minutes for the employee having the employee ID of 4785 since the information stored by work hours data record field 420 indicates that the employee worked from 9:08 AM-12:30 PM and from 1:30 PM-5:39 PM and the information stored by shift data field 410 indicates a shift time of 9:00 AM-5:00 PM. Thus, time by type field 430 may store a value of 412 corresponding to the regular time type and the employee ID of 4785.

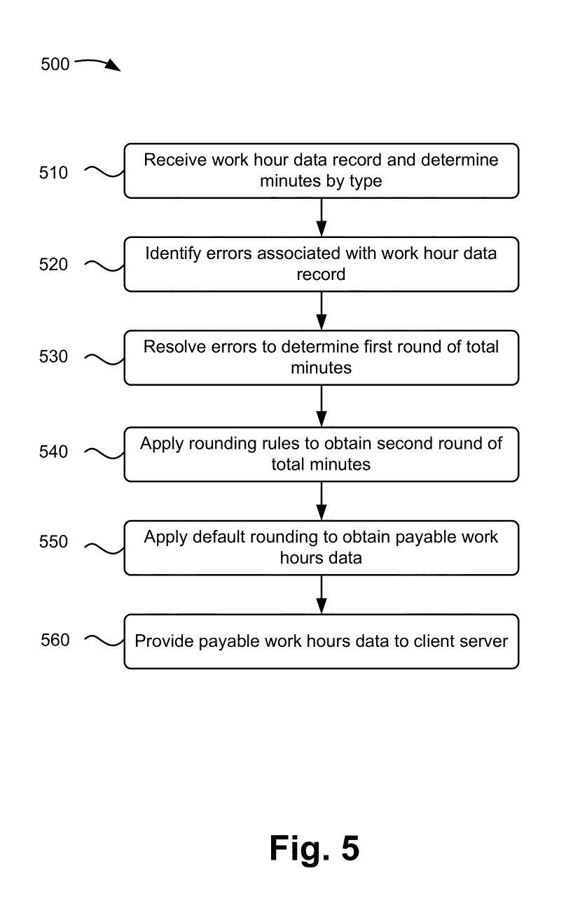

Rounding rule field 440 may store information to identify a rounding rule set (e.g., a rounding rule ID) associated with a particular employee ID. In some implementations, data integration server 230 may receive a rounding rule ID from raw data server 220 as part of a work hours data record. Alternatively, data integration server 230 may receive a rounding rule ID from some other source (e.g., an administrative device or function of data integration server 230 to input a rounding rule ID corresponding to a particular employee ID). As described above, data integration server 230 may apply multiple levels of rounding to minutes, associated with a particular employee ID, to form payable work hours data. Further, data integration server 230 may provide, to client server 240, the payable work hours data. For example, data integration server 230 may form payable work hours data by rounding the number of tardy minutes either up or down, rounding the number of regular minutes either up or down, or rounding the number of overtime minutes either up or down based on a corresponding rounding rule. An example of data integration server 230 applying a particular rounding rule set corresponding to information stored by rounding rule field 440 is described below with respect to rounding rule field 460 and FIG. 5.

As shown in FIG. 4B, error processing field 450 may store information associated with error types for a work hours data record received by raw data server 220. For example, data integration server 230 may receive a work hours data record, from raw data server 220, having an error (e.g., a record with an invalid employee ID, an invalid rounding rule ID, a duplicate entry, etc.). Each entry of error processing field 450 may store a particular error type as uniquely identified by an error type ID and an error description. Further, error processing field 450 may store information (e.g., in an error resolution field of error processing field 450) to identify an instruction to direct data integration server 230 to resolve an error based on the error type ID of an error. As an example, error processing field 450 may store an error resolution instruction (e.g., for a work hours data record having an invalid employee ID), to direct data integration server 230 to identify a missing employee ID record, apply hours, associated with the work hours data record, to the identified employee ID, and confirm (e.g., via an administrative interface device of data integration server 230) the applied hours with the identified employee ID.

As shown in FIG. 4C, rounding rule field 460 may store information to identify a set of rounding rules to apply to information stored by time by type field 430 (e.g., a set of rounding rules to direct data integration server 230 to round minutes stored by time by type field 430 either up or down). Data structure 400 may include multiple rounding rule fields 460 having a respective set of rounding rules. In FIG. 4C, assume that rounding rule field 460 stores a set of rounding rules corresponding to the rounding rule ID of 123. Thus, rounding rule field 460 may store a rounding rule ID of 123 as shown in FIG. 4C. As further shown in FIG. 4C, rounding rule field 460 may identify a rule to direct data integration server 230 to round up regular minutes (e.g., minutes stored by time by type field 430 associated with the regular minute type) to the nearest multiple of three (e.g., as indicated by the rule “=CEILING(N,3)”). For example, when time by type field 430 stores a value of one regular minute, data integration server 230 may round the value of one regular minute to a value of three regular minutes. As further shown in FIG. 4C, rounding rule field 460 may store a rule to direct data integration server 230 to round up overtime minutes by a multiple of five (e.g., as indicated by the rule “=CEILING(X,5) and round down tardy minutes by a multiple of 10 (e.g., as indicated by the rule “=FLOOR(Y,10). Rounding rule field 460 may also store a default rounding rule to direct data integration server 230 to round up total minutes by a multiple of 10 (e.g., when data integration server 230 determines total minutes by applying rounding rules for regular minutes, overtime minutes, and tardy minutes, as described above).

While particular fields are shown in a particular format in data structure 400, in practice, data structure 400 may include additional fields, fewer fields, different fields, or differently arranged fields than are shown in FIGS. 4A-4C.

FIG. 5 illustrates a flowchart of an example process 500 for applying a set of rounding rules to determine payable work hours data. In one implementation, process 500 may be performed by one or more components of data integration server 230. In another implementation, some or all of blocks of process 500 may be performed by one or more components of another device in environment 200 (e.g., user device 210, raw data server 220, or client server 240), or a group of devices including or excluding data integration server 230.

As shown in FIG. 5, process 500 may include receiving a work hours data record and determining minutes by type (block 510). For example, data integration server 230 may receive a work hours data record from raw data server 220. As described above, the work hours data record may include information to identify an employee ID and time periods in which an employee, associated with the employee ID, conducted work-related tasks. Data integration server 230 may determine a number of minutes, corresponding to the time periods of the work hours data record, and may determine types associated with the minutes. For example, as described above, data integration server 230 may determine a number of tardy minutes, a number of regular minutes, and a number of overtime minutes based on information stored by data structure 400. Data integration server 230 may also identify total minutes for a particular work shift based on work shift information stored by data structure 400.

Process 500 may also include identifying errors associated with the work hours data record (block 520) and resolving the errors to determine first total minutes (block 530). For example, data integration server 230 may identify a data error, such as an invalid employee ID error (e.g., when the employee ID of the work hours data record does not match an employee ID stored by data integration server 230), an invalid rounding rule ID error (e.g., when the rounding rule ID of the work hours data record does not match an employee ID stored by data integration server 230), a duplicate entry error (e.g., when the work hours data record includes work hours data for an employee ID having work hours data already stored by data integration server 230), or some other type of error.

In some implementations, data integration server 230 may resolve the errors based on error resolution instructions stored by data structure 400. For example, data integration server 230 may subtract duplicate hours based on identifying a duplicate work hours data record. Additionally, or alternatively, (e.g., in the case where a work hours data record includes an invalid employee ID error type), data integration server 230 may identify an employee ID with a missing work hours data record (e.g., by performing a reverse look-up function), and apply hours from the work hours data record having the invalid employee ID to the identified employee ID. Additionally, or alternatively, data integration server 230 may modify work hours information stored by time by type field 430 in some other manner to resolve errors associated with a data record. Thus, data integration server 230 may determine first total minutes associated with an employee ID, and the type of minutes, based on resolving errors associated with the data record.

Process 500 may further include applying rounding rules to the first total minutes to obtain second total minutes (block 540). For example, data integration server 230 may apply rounding rules to round down or up regular minutes, round down or up tardy minutes, round down or up overtime minutes, or round down or up some other type of minutes based on rounding rules information stored by data structure 400 (e.g., to obtain rounded regular minutes, rounded tardy minutes, and rounded overtime minutes, respectively). In some implementations, the second total minutes may be expressed in terms of second regular minutes and second overtime minutes (e.g., to allow client server 240 to apply different payment rates for regular minutes and overtime minutes).

In some implementations, data integration server 230 may determine the second total minutes based on an algorithm. For example, data integration server 230 may determine the second regular minutes by rounding down or up tardy minutes and deducting the rounded tardy minutes from total shift minutes, by rounding up or down overtime minutes and adding the rounded overtime minutes to the regular minutes against the tardy minutes or rounded tardy minutes, or based on some other algorithm.

In some implementations, data integration server 230 may determine a number of second regular minutes using the formula: second regular minutes=total work shift minutes−rounded tardy minutes+rounded overtime minutes. The second regular minutes may be rounded again corresponding to an associated rounding rule, as descried below with respect to block 550. In some implementations, the second regular minutes may be capped at a maximum number of minutes corresponding to the number of total shift minutes (e.g., in order to determine second overtime minutes). In some implementation, data integration server 230 may determine a number of second overtime minutes by applying a rounding rule to a value corresponding to the difference between overtime minutes and tardy minutes.

As an example, assume that data integration server 230 identifies first total minutes including eight tardy minutes, 39 overtime minutes, 412 regular minutes, and 420 total shift minutes (e.g., based on receiving a work hours data record, determining minutes by type, and resolving errors associated with the data record). Further assume that the first total minutes is associated with a set of rounding rules that direct data integration server 230 to round up regular minutes to the nearest multiple of three, round up overtime minutes to the nearest multiple of five, and round down tardy minutes to the nearest multiple of 10. Given these assumptions, data integration server 230 may determine a second total minutes including 420 second regular minutes (e.g., 412 regular minutes+39 overtime minutes with a maximum of 420 regular minutes), and including 35 second overtime minutes (e.g., by applying a rounding rule to round up overtime minutes to the nearest multiple of five and deducting 8 tardy minutes from 39 overtime minutes).

As another example, assume that data integration server 230 identifies a first total minutes including eight tardy minutes and 420 total work shift minutes (e.g., based on receiving a work hours data record, determining minutes by type, and resolving errors associated with the data record). Further assume that the first round of minutes is associated with a set of rounding rules that direct data integration server 230 to round down tardy minutes to the nearest multiple of 10. Given these assumptions, data integration server 230 may determine a rounded number of tardy minutes of zero and a second total minutes including 420 second regular minutes (e.g., total work shift minutes (420)−rounded tardy minutes (0)).

As another example, assume that data integration server 230 identifies a first round of minutes of 19 tardy minutes and 420 total work shift minutes (e.g., based on receiving a work hours data record, determining minutes by type, and resolving errors associated with the data record). Further assume that the first round of minutes is associated with a set of rounding rules that direct data integration server 230 to round down tardy minutes to the nearest multiple of 10. Given these assumptions, data integration server 230 may determine a rounded number of tardy minutes of 10 and a second total minutes including 410 second regular minutes (e.g., total work shift minutes (420)−rounded tardy minutes (10)).

Process 500 may further include applying default to obtain payable work hours data (block 550). For example, data integration server 230 may apply a default rounding rule to the second total minutes to obtain payable work hours data. In some implementations, the default rounding rule may correspond to information stored by rounding rule field 460. As an example, assume that data integration server 230 determines second total minutes including 411 second regular minutes associated with a default rounding rule to direct data integration server 230 to round up the second regular minutes to the nearest multiple of 10. Given this assumption, data integration server 230 may determine payable work hours data including 420 payable regular minutes.

As another example, assume that data integration server 230 determines a second total minutes including 420 second regular minutes and 21 second overtime minutes. Further assume that the second total minutes is associated with a default rounding rule to direct data integration server 230 to round up the second round of overtime minutes to the nearest multiple of 10. Given this assumption, data integration server 230 may determine payable work hours data including 420 payable regular minutes and 30 payable overtime minutes.

Process 500 may further include providing the payable work hours data to a client server (block 560). For example, data integration server 230 may provide the payable work hours data to client server 240 so that client server 240 may determine payments to process based on payable regular minutes data and payable overtime minutes. As described above, the payable regular minutes data may be associated with a first payment rate and the payable overtime minutes data may be associated with a second payment rate. Thus, client server 240 may determine payments in accordance with rounding rules and in accordance with different payment rates for regular and overtime minutes. In some implementations, client server 240 may convert minutes to hours or some other unit of measure in order to process payments.

While a particular series of blocks has been described above with regard to FIG. 5, the operations, data flows, and/or the order of the blocks may be modified in other implementations. Further, non-dependent operations and/or data flows may be performed in parallel. Further, while example algorithms have been described above with respect to blocks 540-550, in practice, data integration server 230 may apply any number of algorithms having different rounding rules and orders of operations than described.

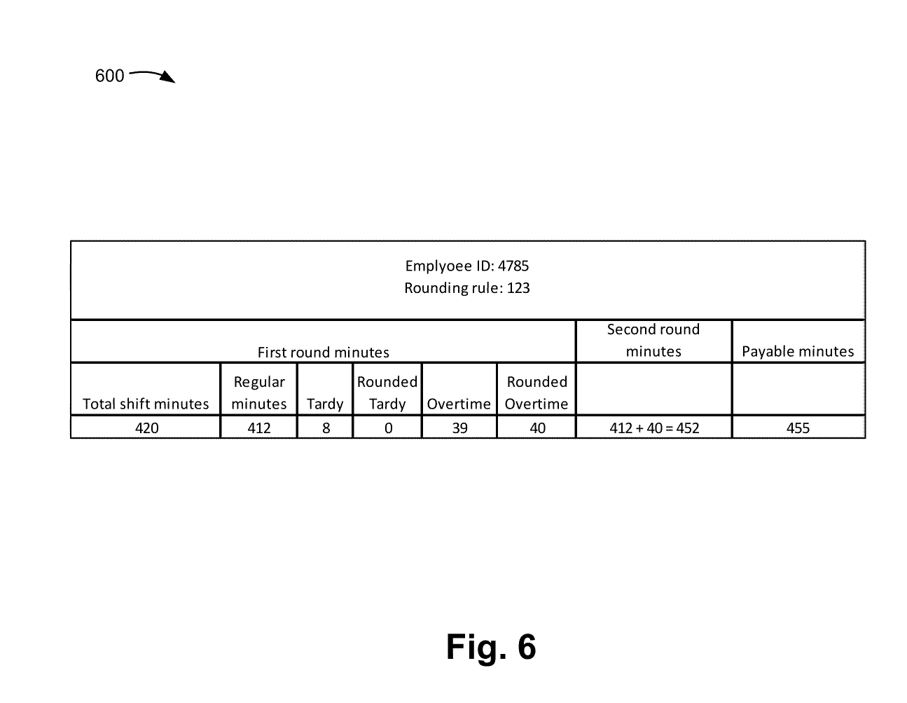

FIG. 6 illustrates an example use case for calculating payable minutes. In FIG. 6, assume that data integration server 230 receives work hours data for a particular employee having the employee ID of 4785. For example, assume that data integration server 230 receives the work hours data and determines first round minutes (e.g., based on performing error processing to determine first round minutes, as described above) corresponding to information stored by data structure 600. Given these assumptions, data integration server 230 may determine second round minutes of 452 (e.g., by adding regular minutes and rounded overtime minutes). Further, data integration server 230 may determine payable minutes by rounding the second round of minutes based on a corresponding rounding rule (e.g., a rounding rule having the rounding rule ID of 123). In some implementations, data integration server 230 may provide data structure 600 to present minutes, associated with a particular employee, in a chart format.

As described above, data integration server 230 may receive work hours data in the form of a work hours data record and may apply multiple levels of rounding rules to generate payable work hours data. In some implementations, data integration server 230 may provide the payable work hours data to client server 240 (e.g., a wage payment processing server) in a format that identifies wage hours by hours type (e.g., payable regular hours, payable overtime hours, etc.). In some implementations, client server 240 may store information that identifies wage payment rates by hour type and may determine wage payments for individual users (e.g., individual employees). Thus, client server 240 may determine wage payments in accordance with a set of rounding rules (e.g., rounding rules corresponding to a CBA), without providing wage rate information to data integration server 230.

The foregoing description provides illustration and description, but is not intended to be exhaustive or to limit the possible implementations to the precise form disclosed. Modifications and variations are possible in light of the above disclosure or may be acquired from practice of the implementations.

It will be apparent that different examples of the description provided above may be implemented in many different forms of software, firmware, and hardware in the implementations illustrated in the figures. The software code or specialized control hardware used to implement these examples is not limiting of the implementations. Thus, the operation and behavior of these examples were described without reference to the specific software code—it being understood that software and control hardware can be designed to implement these examples based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

What is claimed is:

1. A method comprising:
storing, by a first server, a first start time and a first end time;
receiving, by the first server, a first data record having a second start time and a second end time;
determining, by the first server, a first number of time units corresponding to a total number of time units between the first start time and the first end time;
determining, by the second server, a second number of time units corresponding to a difference between the first start time and the second start time;
applying, by the first server, a first rounding rule, associated with the second number of time units, to the second number of time units to form a first rounded number;
determining, by the first server, a second rounded number by subtracting the first rounded number from the first number of time units;
applying, by the first server, a second rounding rule to the second rounded number to form a third rounded number; and
providing, by the first server, the third rounded number to a second server,
the second server determining a payment based on a first payment rate and the third rounded number.

2. The method of claim 1, further comprising:
determining a third number of time units corresponding to a difference between the second end time and the first end time;
applying a third rounding rule, associated with the third number of time units, to form a fourth rounded number; and
providing the fourth rounded number to the second server,
the second server determining the payment further based on a second payment rate and the fourth rounded number.

3. The method of claim 2, further comprising:
adding the third number of time units to the second rounded number;
reducing the second rounded number to the first number of time units when the sum of the third number of time units and the second rounded number exceeds the first number of time units;
where determining the second rounded number is further based on adding the third number of time units to the second rounded number and reducing the second rounded number to the first number of time units.

4. The method of claim 1, further comprising:
determining that the first data record includes an error;
determining a resolution rule based on the error; and
modifying the first data record using the resolution rule,
where determining the first number of time units and the second number of time units is based on modifying the first data record.

5. The method of claim 1, further comprising:
receiving a second data record;
determining that the second data record is a duplicate of the first data record; and
deleting the second data record based on determining that the second data record is a duplicate of the first data record.

6. The method of claim 1, where the first rounding rule or the second rounding rule is based on a collective bargaining agreement (CBA).

7. The method of claim 1, where the first server receives the first data record from a third server,
the third server receiving the information associated with the second start time and the second end time from a device that tracks work hours corresponding to the second start time and the second end time.

8. A system comprising:
a first server to:
store a first start time and a first end time;
receive a first data record having a second start time and a second end time;
determine a first number of time units corresponding to a total number of time units between the first start time and the first end time;
determine a second number of time units corresponding to a difference between the first start time and the second start time;
apply a first rounding rule, associated with the second number of time units, to the second number of time units and to form a first rounded number;
determine a second rounded number by subtracting the first rounded number from the first number of time units;
apply a second rounding rule, to the second rounded number to form a third rounded number;
provide the third rounded number to a second server;
determine a third number of time units corresponding to a difference between the second end time and the first end time when the second end time is later than the first end time;
apply a third rounding rule, associated with the third number of time units, to form a fourth rounded number; and
provide the fourth rounded number to the second server,
the second server determining a payment based on a first payment rate, the third rounded number, a second payment rate, and the fourth rounded number.

9. The system of claim 8, where the first server is further to:
add the third number of time units to the second rounded number;
reduce the second rounded number to the first number of time units when the sum of the third number of time units and the second rounded number exceeds the first number of time units;
where when determining the second rounded number, the first server is further to determine the second rounded number further based on adding the third number of time units to the second rounded number and reducing the second rounded number to the first number of time units.

10. The system of claim 8, where the first server is further to:
determine that the first data record includes an error;
determine a resolution rule based on the error; and
modify the first number of time units using the resolution rule,
where determining the first number of time units is further based on modifying the first number of time units.

11. The system of claim 8, where the first server is further to:
receive a second data record;
determine that the second data record is a duplicate of the first data record; and
delete the second data record based on determining that the second data record is a duplicate of the first data record.

12. The system of claim 8, where the first rounding rule or the second rounding rule is based on a collective bargaining agreement (CBA).

13. The system of claim 8, where the first server receives the data record from a third server,
the third server receiving the information associated with the second start time and the second end time from a device that tracks work hours corresponding to the second start time and the second end time.

14. A computer-readable medium for storing instructions, the instructions comprising:
a plurality of instructions which, when executed by one or more processors associated with a first server, cause the one or more processors to:
store a first start time and a first end time;
receive a first data record having a second start time and a second end time;
determine a first number of time units corresponding to a total number of time units between the first start time and the first end time;
determine a second number of time units corresponding to a difference between the first end time and the second end time;
apply a first rounding rule, associated with the second number of time units, to the second number of time units to form a first rounded number; and
provide the first rounded number to a second server,
the second server determining a payment based on a first payment rate and the first rounded number.

15. The computer-readable medium of claim 14, where the plurality of instructions further cause the one or more processors to:
determine a third number of time units corresponding to a difference between the first start time and the second start time when the second start time is later than the first start time;
apply a second rounding rule, associated with the third number of time units, to round the third number of time units to form a second rounded number;
determine a third rounded number by subtracting the second rounded number from the first number of time units;
apply a third rounding rule to the third rounded number to form a fourth rounded number; and
provide the fourth rounded number to the second server,
the second server determining the payment based on a second payment rate and the fourth rounded number.

16. The computer-readable medium of claim 15, where the plurality of instructions further cause the one or more processors to:
add the third number of time units to the second rounded number;
reduce the second rounded number to the first number of time units when the sum of the third number of time units and the second rounded number exceeds the first number of time units;
where one or more instructions, of the plurality instructions, to determine the second rounded number, further cause the one or more processors to determine the second rounded number based on adding the third number of time units to the second rounded number and reducing the second rounded number to the first number of time units.

17. The computer-readable medium of claim 14, where the plurality of instructions further cause the one or more processors to:
determine that the first data record includes an error;
determine a resolution rule based on the error; and
modify the first data record using the resolution rule,
where one or more instructions, of the plurality of instructions, to determine the first number of time units and the second number of time units, further cause the one or more processors to determine the first number of time units and the second number of time units based on modifying the data record.

18. The computer-readable medium of claim 14, where the plurality of instructions further cause the one or more processors to:
receive a second data record;
determine that the second data record is a duplicate of the first data record; and
delete the second data record based on determining that the second data record is a duplicate of the first data record.

19. The computer-readable medium of claim 14, where the first rounding rule is based on a collective bargaining agreement (CBA).

20. The computer-readable medium of claim 14, where the first server receives the data record from a third server,
the third server receiving the information associated with the second start time and the second end time from a device that tracks work hours corresponding to the second start time and the second end time.
